(19) United States
(12) Patent Application Publication
(10) Pub. No.: US 2007/0281068 A1
(43) Pub. Date: Dec. 6, 2007

(54) Organic Ready-To-Feed Liquid Nutritional Formula Containing Select Carbohydrate Combinations

(76) Inventors: Jeffrey M. Boff, Dublin, OH (US); Jennifer L. Kaiser, Columbus, OH (US)

Correspondence Address: William J. Winter;Ross Products Division of Abbot Laboratories, Dept. 108140-DS-1, 625 Cleveland Avenue, Columbus, OH, 43215-1724, US

(21) Appl. No.: 11/693,031

(22) Filed: Mar. 29, 2007

Related U.S. Application Data
(63) Continuation-in-part of application No. 11/444,001, filed on May 31, 2006.

(51) Int. Cl. A23L 2/38; A23C 9/00; A23J 1/00

(52) U.S. Cl. 426/588; 426/590; 426/656

(57) ABSTRACT

Disclosed are organic ready-to-feed liquid nutritional formulas, including infant formulas, comprising organic lipid, organic protein, and organic carbohydrate, wherein the organic carbohydrate is a blend containing at least one carbohydrate selected from organic maltodextrin, organic corn syrup solids, and organic corn syrup, and at least one carbohydrate selected from organic sucrose and organic lactose. The organic ready-to-feed liquid nutritional formulas provide improved physical appearance due to improved lighter, whiter color.

### CROSS-REFERENCE TO RELATED APPLICATION

This application is a continuation-in-part of U.S. patent application Ser. No. 11/444,001, filed on May 31, 2006.

### TECHNICAL FIELD

The present invention relates to organic ready-to-feed liquid nutritional formulas comprising select organic carbohydrate combinations.

### BACKGROUND OF THE INVENTION

A variety of nutritional formulas are commercially available today. These formulas typically contain a balance of proteins, carbohydrates, lipids, vitamins, and minerals tailored to the nutritional needs of the intended user, and include product forms such as ready-to-drink liquids, reconstitutable ready-to-feed liquids, nutritional bars, and others. Among the many nutritional formulas commercially available today, infant formulas have become particularly well known and commonly used in providing a supplemental, primary, or sole source of nutrition early in life.

Organic nutritionals, in particular, have become increasingly popular among a growing population of health conscious consumers. Organic nutritionals are made from organic ingredients which are grown and prepared without the use of chemical pesticides, growth hormones, antibiotics, herbicides or synthetic fertilizers, are processed without the use of solvents, and are not genetically modified. A growing number of individuals are turning to organic foods as their preferred source of nutrition because the consuming public is aware that organic foods reduce the health risks associated with consuming foods that are potentially tainted with chemical solvents, pesticides, herbicides, and the like.

A number of countries have procedures and regulations that must be followed for a food product to be labeled as organic. The United States Department of Agriculture National Organic Program (USDA NOP) has developed national organic standards and established an organic certification program. The USDA NOP regulations require that products labeled as “organic” must contain at least 95 percent organically produced raw or processed agricultural ingredients. Any remaining product ingredients must be organically produced, unless not commercially available in organic form. The USDA's 95% requirement is consistent with the standards in Japan, the European Union, and Canada.

An increasing number of organic food products have become commercially available, including organic infant formulas as well as other organic nutritional formulas. These products tend to have limited distribution and are costly. This is due, in part, to limited availability of organic ingredients in sufficient quantities for use in such products. Organic ingredients are not as readily available on a large-scale basis, because only approximately 4% of the world's farmers practice organic farming. Furthermore, since organic food products are prepared without the use of chemical pesticides, growth hormones, antibiotics, herbicides or synthetic fertilizers and are processed without the use of solvents, the physical appearance and physical quality of some organic food products may be inferior to some non-organic food products, thus further limiting the supply of acceptable organic ingredients for use in an organic food product.

Organic infant formulas have become increasingly popular as a commercially available organic food product. As a regulated food product, organic or otherwise, infant formulas must contain a defined balance of fats, proteins, carbohydrates, vitamins, and minerals. Most organic infant formulas typically contain organic lactose as the sole added carbohydrate source. The use of organic lactose, however, especially at the higher concentrations used in organic infant formulas, is limited by high material costs and limited commercial availability.

It would therefore be desirable to formulate an organic liquid infant formula or other organic nutritional formula with an alternative carbohydrate source such as organic maltodextrin, organic corn syrup solids, organic corn syrup, or combinations thereof, supplies of which are more readily available than current organic lactose supplies.

As discussed above, the physical appearance and physical quality of some organic food products may be inferior to their non-organic counterparts. In judging the quality and consistency of a product, either organic or non-organic, the consumer is strongly influenced by its appearance. It is well known that thermal processing of nutritionals typically impart brown and gray hues to the final product color, which negatively impacts the overall appeal of the nutritional. Manufacturers have been challenged to produce thermally processed nutritionals that are white in appearance. It is well known that infant formulas with lighter, whiter color are more appealing to and preferred by consumers.

Applicants found that organic powder nutritional formulas containing organic maltodextrin, organic corn syrup solids, and/or organic corn syrup can be formulated in combination with organic lactose, organic sucrose, or both, to effectively minimize or eliminate granular residue in the final organic powder nutritional product and to improve dispersibility. However, these organic powder nutritional formulas are darker in color than non-organic powder formulas.

It has now been discovered herein that organic ready-to-feed liquid nutritional formulas may also be successfully formulated with alternative carbohydrate sources other than or in addition to lactose. Specifically, organic ready-to-feed liquid nutritional products containing organic maltodextrin, organic corn syrup solids, and/or organic corn syrup may be formulated in combination with organic lactose, organic sucrose, or both. It has been found, surprisingly, that rather than being darker or inferior in color to their non-organic counterparts, the organic ready-to-feed liquid nutritional formulations of the present invention exhibit an improved color that is lighter or whiter as compared to non-organic ready-to-feed liquid nutritional products.

### SUMMARY OF THE INVENTION

The present invention is directed to organic ready-to-feed liquid nutritional formulas, including organic ready-to-feed liquid infant formulas, comprising organic lipid, organic protein, and organic carbohydrate, wherein the organic carbohydrate is a blend containing at least one ingredient selected from organic maltodextrin, organic corn syrup solids, and organic corn syrup, and at least one ingredient selected from organic sucrose and organic lactose.

It has been found, surprisingly, that the organic ready-to-feed liquid nutritional formulas of the present invention, which are formulated with alternative carbohydrate sources other than or in addition to lactose, have improved physical appearance due to providing a lighter, whiter color. The organic ready-to-feed liquid nutritional formulations of the present invention exhibit improved lighter, whiter color as compared to other non-organic ready-to-feed liquid nutritional products.

### DETAILED DESCRIPTION OF THE INVENTION

The organic ready-to-feed liquid nutritional formulas of the present invention comprise organic lipid, organic protein, and select combinations of organic carbohydrates. These and other essential or optional elements or limitations of the organic ready-to-feed liquid nutritional formulas of the present invention are described in detail hereinafter.

The term “infant” as used herein, unless otherwise specified, refers to children not more than about one year of age, and includes infants from 0 to about 4 months of age, infants from about 4 to about 8 months of age, infants from about 8 to about 12 months of age, low birth weight infants at less than 2,500 grams at birth, and preterm infants born at less than about 37 weeks gestational age, typically from about 26 weeks to about 34 weeks gestational age. The term “child” and “children” as used herein refers to children not more than 12 years of age, and includes children from about 12 months to about 12 years of age. The term “adult” as used herein refers to adults and children about 12 years and older.

The term “infant formula” as used herein, unless otherwise specified, refers to a nutritional composition designed for infants that contains sufficient nutrients such as proteins, carbohydrates, lipids, vitamins, and minerals to potentially serve as a supplemental, primary, or sole source of nutrition.

The term “organic infant formula” as used herein, unless otherwise specified, refers to an infant formula comprising at least 95 percent (by weight, excluding water) organically produced, raw or processed, agricultural ingredients. Any remaining product ingredients must be organically produced, unless not commercially available in organic form.

The term “nutritional formula” as used herein, unless otherwise specified, refers to a nutritional composition designed for infants, toddlers, children, adults, or combinations thereof, that contains sufficient nutrients such as proteins, carbohydrates, lipids, vitamins, minerals, and or electrolytes to potentially serve as a supplemental, primary, or sole source of nutrition.

The term “organic nutritional formula” as used herein, unless otherwise specified, refers to a nutritional formulation comprising at least 95 percent (by weight, excluding water) organically produced, raw or processed, agricultural ingredients. Any remaining product ingredients must be organically produced, unless not commercially available in organic form.

The term “organic” as used herein, unless otherwise specified, in reference to any individual organic raw ingredient, refers to a raw ingredient obtained from a producer or handler of a production or handling operation that has produced or handled the raw ingredient, under an organic production or organic handling system plan that is agreed to by the producer or handler and an accredited certifying agent.

The term “non-GMO” as used herein, unless otherwise specified, in reference to a non-organic agricultural raw ingredient, refers to an ingredient that is not produced from a genetically modified organism. Non-organic agricultural raw ingredients for use herein are preferably non-GMO.

The term “non-GMO” as used herein, unless otherwise specified, in reference to a non-organic, non-agricultural raw ingredient, refers to an ingredient that is free from modified deoxyribonucleic acid (DNA) or the proteins from genetically modified DNA. Non-organic, non-agricultural, raw ingredients for use herein are preferably non-GMO.

The term “ready-to-feed” as used herein, unless otherwise specified, refers to nutritional formulas in liquid form, suitable for administration without further dilution, including ready-to-feed manufactured liquids.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

All weight ratios or weight percentages, as used herein for the organic carbohydrate combinations, unless otherwise specified, are based on organic carbohydrates that are added to the organic ready-to-feed liquid nutritional formulas as individual organic carbohydrate ingredients and do not include inherent organic carbohydrates provided from other added ingredients, e.g., inherent lactose provided from added organic non-fat dry milk.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein may be performed in any order, unless otherwise specified or clearly implied to the contrary by the context in which the referenced combination is made.

The organic ready-to-feed liquid nutritional formulas of the present invention may also be substantially free of any optional or selected essential ingredient or feature described herein, provided that the remaining formula still contains all of the required ingredients or features as described herein. In this context, and unless otherwise specified, the term “substantially free” means that the selected composition contains less than a functional amount of the optional ingredient, typically less than 0.1% by weight, and also including zero percent by weight of such optional or selected essential ingredient.

The organic ready-to-feed liquid nutritional formulas and corresponding methods of the present invention may comprise, consist of, or consist essentially of the essential elements and limitations of the invention described herein, as well as any additional or optional ingredients, components, or limitations described herein or otherwise useful in organic ready-to-feed liquid nutritional formula applications.

### Carbohydrates

The organic ready-to-feed liquid nutritional formulas of the present invention comprise at least one organic carbohydrate (first carbohydrate) selected from organic maltodextrin, organic corn syrup, and organic corn syrup solids, and at least one organic carbohydrate (second carbohydrate) selected from organic sucrose and organic lactose.

The organic ready-to-feed liquid nutritional formulas of the present invention comprise organic lipid, organic protein, and organic carbohydrate, wherein the organic carbohydrate is a blend containing at least one carbohydrate selected from organic maltodextrin, organic corn syrup solids, and organic corn syrup, and at least one carbohydrate selected from organic sucrose and organic lactose. The preferred weight ratio of organic maltodextrin, organic corn syrup solids, and/or organic corn syrup to organic sucrose, organic lactose, or both, is from about 1:10 to about 10:1, more preferably from about 5:1 to about 1:3, including from about 3:1 to about 1:1.

The organic ready-to-feed liquid infant formula embodiments of the present invention include those embodiments comprising organic lipid, organic protein, and organic carbohydrate, wherein the organic carbohydrate is a blend of organic maltodextrin and organic sucrose. The weight ratio of organic maltodextrin to organic sucrose preferably ranges from about 1:10 to about 10:1, more preferably from about 5:1 to about 1:3, including from about 3:1 to about 1:1.

The weight ratios, as used herein for the organic carbohydrate combinations, are based on organic carbohydrates that are added to the organic ready-to-feed liquid nutritional formulas as individual organic carbohydrate ingredients and do not include inherent organic carbohydrates provided in other added ingredients. A non-limiting example of an inherent organic carbohydrate that is not included in the weight ratios, as used herein, is inherent lactose provided from added organic non-fat dry milk.

The organic carbohydrates for use in the organic ready-to-feed liquid nutritional formulas of the present invention may be obtained from any known or otherwise suitable certified organic material source. The organic carbohydrates must be obtained from a producer or handler of a production or handling operation that has produced or handled the carbohydrate, under an organic production or organic handling system plan that is agreed to by the producer or handler and an accredited certifying agent. A limited number of commercial certified sources are available.

The organic ready-to-feed liquid nutritional formulas of the present invention may comprise organic lactose, a disaccharide consisting of two subunits, a galactose and a glucose linked together by a glycosidic bond. Organic lactose for use in the organic ready-to-feed liquid nutritional formulas of the present invention is typically derived or otherwise obtained from cow's milk, which generally contains about 5% lactose. The organic lactose can be added in purified or partially purified form. A limited number of commercial sources of organic lactose are available because there are only a limited number of commercial sources of cow's milk, from which lactose is derived, which do not use hormones, steroids or antibiotics on the cattle and only feed organic grains and grasses to the cattle. Non-limiting examples of some suitable sources of organic lactose include organic lactose from Marroquin International, Santa Cruz, Calif., USA; and organic lactose from Horizon Dairy, Boulder, Colo., USA.

The organic ready-to-feed liquid nutritional formulas of the present invention may comprise organic sucrose, a disaccharide consisting of two subunits, a fructose and a glucose linked together by a glycosidic bond. Organic sucrose for use in the organic ready-to-feed liquid nutritional formulas of the present invention is typically extracted from organic sugar cane or organic sugar beet and then purified and crystallized. Non-limiting examples of some suitable sources of organic sucrose include organic sucrose from Florida Crystals, West Palm Beach, Fla., USA; and organic sucrose from Marroquin International, Santa Cruz, Calif., USA. Organic sucrose is preferred over organic lactose. Although organic lactose is suitable for use herein, the compositions are preferably substantially free of added organic lactose. In this context, the formulas of the present invention preferably contain less than 1.0%, including less than 0.5%, and also including zero percent, by weight of added organic lactose.

The organic ready-to-feed liquid nutritional formulas of the present invention may comprise organic corn syrup, known as glucose syrup outside Canada and the United States. Organic corn syrup is derived from partial hydrolysis of organic corn starch and is composed mainly of glucose. A limited number of commercial sources of organic corn syrup are available because organic corn syrup must be derived from an organic corn crop. Non-limiting examples of some suitable sources of organic corn syrup include organic corn syrup from Agrana Beteiligungs-AG, Vienna, Austria; and organic corn syrup from Marroquin International, Santa Cruz, Calif., USA.

The organic ready-to-feed liquid nutritional formulas of the present invention may comprise organic maltodextrin. Maltodextrins are partially hydrolyzed starch molecules, comprising a series of D-glucose units linked primarily by alpha-1-4 bonds. Maltodextrins, as an ingredient class, are not sweet and have DE values of less than 20. DE values are conventional measurements of the average reducing power of maltodextrin or other polysaccharide as compared to a dextrose standard. Organic maltodextrins having DE values of less than about 20 are suitable for use herein.

Organic maltodextrins suitable for use in the organic ready-to-feed liquid nutritional formulas of the present invention may be derived from any known or otherwise suitable organic source such as organic corn, organic rice or organic potatoes. Non-limiting examples of some suitable sources of organic maltodextrin include organic corn maltodextrin from Agrana Beteiligungs-AG, Vienna, Austria; and organic rice maltodextrin from California Natural Products, Lathrop, Calif., USA.

The organic ready-to-feed liquid nutritional formulas of the present invention may comprise organic corn syrup solids. Corn syrup solids are partially hydrolyzed corn starch molecules that are dried to a low moisture powder. Corn syrup solids, as an ingredient class, are moderately sweet and have DE values of 20 or greater. Organic corn syrup solids having DE values of about 20 or greater are suitable for use herein. Non-limiting examples of some suitable sources of organic corn syrup solids include organic corn syrup solids from Agrana Beteiligungs-AG, Vienna, Austria; and organic corn syrup solids from Marroquin International, Santa Cruz, Calif., USA.

### Other Nutrients

The organic ready-to-feed liquid nutritional formulas of the present invention may comprise sufficient types and amounts of other nutrients to meet the targeted dietary needs of the intended user. These organic ready-to-feed liquid nutritional formulas may therefore comprise organic protein, organic carbohydrate, and organic lipid as described herein.

The amount of carbohydrate, protein, and lipid in the organic ready-to-feed liquid nutritionals of the present invention may vary considerably depending upon the dietary needs of the intended user as well as many other well known variables. These ingredients, however, are most typically formulated into the organic ready-to-feed liquid formulas of the present invention with the ranges described in the following table.

| | First | Second | Third |
|---|---|---|---|
| Nutrient* | embodiment | embodiment | embodiment |
| Carbohydrate | 20–85 | 30–60 | 35–55 |
| % total calories | | | |
| Lipid | 5–70 | 20–60 | 25–50 |
| % total calories | | | |
| Protein | 2–75 | 5–50 | 7–40 |
| % total calories | | | |

*each numerical value is preceded by the term “about”

Different sources and types of organic lipids and organic proteins are known and may be used in the organic ready-to-feed liquid formulas of the present invention, provided that such nutrients are compatible with the added ingredients in the selected organic formula, are safe for their intended use, and do not otherwise unduly impair product performance.

The organic protein may be any organic protein source appropriate for use in an organic ready-to-feed liquid nutritional formula. Organic proteins suitable for use in the organic ready-to-feed liquid nutritional formulas include, but are not limited to, hydrolyzed, partially hydrolyzed or non-hydrolyzed proteins or protein sources, and can be derived from any known or otherwise suitable source such as milk (e.g., casein, whey), animal (e.g., meat, fish), cereal (e.g., rice, corn), vegetable (e.g., soy), or combinations thereof. The proteins for use herein may also include, or be entirely or partially replaced by, free amino acids known for use in organic ready-to-feed liquid nutritional products, non-limiting examples of which include tryptophan, glutamine, tyrosine, methionine, cysteine, arginine, and combinations thereof.

The organic protein for use herein may include organic non-fat dry milk supplied by a limited number of commercial sources which do not use hormones, steroids or antibiotics on the cattle and only feed organic grains and grasses to the cattle. Non-limiting examples of commercially available organic proteins suitable for use herein include organic non-fat dry milk from Humboldt Creamery, Fortuna, Calif., USA; organic non-fat dry milk from Chicago Dairy Corporation, Lake Forest, Ill., USA; organic non-fat dry milk from Organic Valley Farms, La Farge, Wis., USA; organic non-fat dry milk from Horizon Dairy, Boulder, Colo., USA; organic soy protein isolate from American Health and Nutrition, Inc., Ann Arbor, Mich., USA; and organic whey ready-to-feed liquid from Marroquin International, Santa Cruz, Calif., USA.

The organic ready-to-feed nutritional products of the present invention preferably contain organic non-fat dry milk. Although organic whey protein is suitable for use herein, the compositions are preferably substantially free of added organic whey protein. In this context, the formulas of the present invention preferably contain less than 1.0%, including less than 0.5%, and also including zero percent, by weight of added, non-inherent, organic whey protein. Added organic whey proteins are proteins that are added to the organic ready-to-feed liquid nutritional formulas as individual organic protein ingredients and do not include inherent organic whey proteins provided in other added ingredients. A non-limiting example of an inherent organic protein, as used herein, is inherent whey protein provided from added organic non-fat dry milk.

The organic lipid may be any organic lipid source appropriate for use in an organic ready-to-feed liquid nutritional formula. Non-limiting examples of organic lipids suitable for use herein include organic coconut oil from North Pacific, Portland, Oreg., USA; organic coconut oil from SK Food International, Inc., Fargo, N. Dak., USA; organic coconut oil from Spectrum Organic Products, Inc., Petaluma, Calif., USA; organic soy oil from North Pacific, Portland, Oreg., USA; organic soy oil from SK Food International, Inc., Fargo, N. Dak., USA; organic soy oil from Spectrum Organic Products, Inc., Petaluma, Calif., USA; organic high oleic sunflower oil from North Pacific, Portland, Oreg., USA; organic high oleic sunflower oil from SK Food International, Inc., Fargo, N. Dak., USA; organic high oleic sunflower oil from Spectrum Organic Products, Inc., Petaluma, Calif., USA; organic corn oil, organic olive oil, organic safflower oil, organic high oleic safflower oil, organic MCT (medium chain triglyceride) oil, organic sunflower oil, organic palm and palm kernel oils, organic palm olein, organic canola oil, organic marine oil, organic cottonseed oil, and combinations thereof.

The organic ready-to-feed liquid nutritional formulas of the present invention may further comprise vitamins, minerals or other ingredients suitable for use in a nutritional formula, however, these ingredients are rarely commercially available in organic form. Up to 5% (by weight, excluding water) of ingredients in nutritional products labeled as “organic” can be non-organic, provided these ingredients are not widely available in organic form. Protein, carbohydrate and lipid typically comprise greater than 95% (by weight, excluding water) of the ingredients in an organic nutritional formula, therefore, the vitamins, minerals and other minor ingredients in an organic ready-to-feed liquid nutritional formula can be non-organic provided that the ingredients or any component used in the manufacture of the ingredients are non-GMO.

The organic ready-to-feed liquid nutritional formulas of the present invention may further comprise any of a variety of vitamins, non-limiting examples of which include vitamin A, vitamin D, vitamin E, vitamin K, thiamine, riboflavin, pyridoxine, vitamin B12, niacin, folic acid, pantothenic acid, biotin, vitamin C, choline, carnitine, inositol, and derivatives thereof, and combinations thereof.

The organic ready-to-feed liquid nutritional formulas may further comprise any of a variety of minerals, non-limiting examples of which include calcium, phosphorus, magnesium, iron, zinc, manganese, copper, iodine, sodium, potassium, molybdenum, chromium, selenium, chloride, salts and derivatives thereof, and combinations thereof.

### Optional Ingredients

The organic ready-to-feed liquid nutritional formulas of the present invention may further comprise other optional ingredients that may modify the physical, chemical, aesthetic or processing characteristics of the compositions or serve as additional nutritional components when used in the targeted user population. Many such optional organic or non-GMO ingredients are known or are otherwise suitable for use in organic ready-to-feed liquid nutritional products and may also be used in the organic ready-to-feed liquid nutritional formulas of the present invention, provided that such optional materials are compatible with the essential materials described herein and are otherwise suitable for use in an organic ready-to-feed liquid nutritional formula.

Non-limiting examples of such optional organic or non-GMO ingredients include preservatives, additional anti-oxidants, polyunsaturated fatty acids, emulsifying agents, buffers, colorants, flavors, nucleotides and nucleosides, probiotics, prebiotics, lactoferrin and related derivatives, thickening agents and stabilizers, and so forth.

There may be potential Regulatory hurdles with adding monoglycerides (emulsifying agents) to organic ready-to-feed liquid nutritional products. It has been discovered, however, that removal of monoglycerides from organic ready-to-feed liquid nutritional products adversely affects the physical appearance and physical stability of final ready-to-feed organic liquid nutritional products. It has been found, however, that the physical appearance and physical stability of ready-to-feed organic liquid nutritional products may be improved, upon removal of monoglycerides, by adding or increasing the amount of lecithin in the formulation. The preferred amount of lecithin, as a percentage by weight of the total fat in the nutritional composition, is from about 1.3% to about 5%, more preferably from about 1.5% to about 4.0%, most preferably from about 1.8% to about 3.0%.

### Infant Formula Embodiments

The organic ready-to-feed liquid infant formula embodiments of the present invention preferably comprise nutrients in accordance with the relevant infant formula guidelines for the targeted consumer or user population, an example of which would be the Infant Formula Act, 21 U.S.C. Section 350(a).

The infant formula embodiments of the present invention include those formulas containing the organic carbohydrate, organic lipid, and organic protein concentrations described in the following table.

Organic Ready-to-Feed Liquid Infant Formula Macro Nutrients*

| | | | g/L |
|---|---|---|---|
| | | | (reconstituted, |
| Nutrient | Embodiment | g/100 kcal | as fed) |
| Carbohydrate | 1^{st} embodiment | 8–16 | 54–108 |
| | 2^{nd} embodiment | 9–13 | 61–88 |
| Lipid | 1^{st} embodiment | 3–8 | 20–54 |
| | 2^{nd} embodiment | 4–6.6 | 27–45 |
| Protein | 1^{st} embodiment | 1–6.0 | 7–41 |
| | 2^{nd} embodiment | 1.5–3.4 | 10–24 |

*all numerical values preceded by the term “about”

The infant formula embodiments of the present invention include those that comprise per 100 kcal of formula one or more of the following: vitamin A (from about 250 to about 1250 IU), vitamin D (from about 40 to about 150 IU), vitamin K (at least about 4 mcg), vitamin E (at least about 0.3 IU), vitamin C (at least about 8 mg), thiamine (at least about 8 mcg), vitamin B12 (at least about 0.15 mcg), niacin (at least about 250 mcg), folic acid (at least about 4 mcg), pantothenic acid (at least about 300 mcg), biotin (at least about 1.5 mcg), choline (at least about 7 mg), and inositol (at least about 4 mg).

The infant formula embodiments of the present invention include those that comprise per 100 kcal of formula one or more of the following: calcium (at least about 50 mg), phosphorus (at least about 25 mg), magnesium (at least about 6 mg), iron (at least about 0.15 mg), iodine (at least about 5 mcg), zinc (at least about 0.5 mg), copper (at least about 60 mcg), manganese (at least about 5 mcg), sodium (from about 20 to about 60 mg), potassium (from about 80 to about 200 mg), and chloride (from about 55 to about 150 mg).

### Method of Manufacture

The organic ready-to-feed liquid nutritional formulas of the present invention may be prepared by any known or otherwise effective technique suitable for making and formulating an organic ready-to-feed nutritional formula or similar other formula, variations of which may depend upon variables such as the selected ingredient combination, packaging and container selection, and so forth, for the desired organic ready-to-feed liquid nutritional formula. Such techniques and variations for any given formula are easily determined and applied by one of ordinary skill in the nutritional formulation or manufacturing arts.

The organic ready-to-feed nutritional formulas of the present invention, including the exemplified formulas described hereinafter, can therefore be prepared by any of a variety of known or otherwise effective formulation or manufacturing methods. These methods most typically involve the initial formation of an aqueous slurry containing carbohydrates, proteins, lipids, stabilizers or other formulation aids, vitamins, minerals, or combinations thereof. The slurry is emulsified, pasteurized, homogenized, and cooled. Various other solutions, mixtures, or other materials may be added to the resulting emulsion before, during, or after further processing. The resulting emulsion is then diluted with an appropriate amount of water prior to sterilization to form a ready-to-feed liquid. The completed product may be placed in suitable containers and subjected to terminal sterilization or may be further processed, sterilized and aseptically packaged. Retort terminal sterilization is preferred over aseptic processing and packaging.

The container for use in the compositions and methods of the present invention may be any container suitable for use with liquid nutritional products. Non-limiting examples of such containers include bags, plastic bottles or containers, pouches, metal cans or other containers, glass bottles, juice box-type containers, foil pouches, plastic bags sold in boxes, or any other container meeting the above-described criteria.

Other suitable methods for making nutritional formulas are described, for example, in U.S. Pat. No. 6,365,218 (Borschel, et al.), U.S. Pat. No. 6,589,576 (Borschel, et al.), U.S. Pat. No. 6,306,908 (Carlson, et al.), U.S. Pat. No. 6,096,358 (Murdick, et al.), and U.S. Patent Application WO2004060080 A1 (Luebbers), which descriptions are incorporated herein by reference.

The present invention therefore includes those embodiments directed to methods of making the organic nutritional ready-to-feed liquids described herein. The method comprising the steps of: (A) combining an organic lipid, an organic protein, and an organic carbohydrate, wherein the organic carbohydrate is a blend containing at least one first carbohydrate selected from the group consisting of organic maltodextrin, organic corn syrup solids, and organic corn syrup, and at least one second carbohydrate selected from the group consisting of organic sucrose and organic lactose, and (B) sterilizing the combined ingredients to form an organic ready-to-feed liquid nutritional. Such methods include the manufacture of any formulation variation described herein.

### EXAMPLES

The following examples further describe and demonstrate specific embodiments within the scope of the present invention. The examples are given solely for the purpose of illustration and are not to be construed as limitations of the present invention, as many variations thereof are possible without departing from the spirit and scope of the invention. All exemplified amounts are weight percentages based upon the total weight of the composition, unless otherwise specified.

Each of the exemplified formulas is fed to humans to provide sole, primary, or supplemental nutrition. Each composition contains a carbohydrate blend as described herein, wherein each composition has improved physical appearance due to improved color.

### Examples 1-3

The following examples illustrate organic ready-to-feed liquid nutritional formulas of the present invention, including methods of making and using the organic formulas. Formula ingredients for each batch are listed in the following table.

| | Example 1 | Example 2 | Example 3 |
|---|---|---|---|
| | Quantity per | Quantity per | Quantity per |
| | 45,359 kg | 45,359 kg | 45,359 kg |
| Ingredients | (100,000 lbs) | (100,000 lbs) | (100,000 lbs) |
| Water | 39690 | 39690 | 39690 |
| Organic Non Fat Dry Milk | 1702 | 1702 | 1702 |
| (kg) | | | |
| Organic Maltodextrin (kg) | 1500 | — | 1500 |
| Organic Corn Syrup Solids | — | 1500 | — |
| (kg) | | | |
| Organic Sucrose (kg) | 873 | 873 | 673 |
| Organic Lactose (kg) | — | — | 200 |
| Organic High Oleic Sunflower | 639 | 639 | 639 |
| Oil (kg) | | | |
| Organic Soy Oil (kg) | 479 | 479 | 479 |
| Organic Coconut Oil (kg) | 457 | 457 | 457 |
| Soy Lecithin (kg) | 32.4 | 32.4 | 32.4 |
| Potassium Citrate (kg) | 25.2 | 25.2 | 25.2 |
| Calcium Carbonate (kg) | 17.0 | 17.0 | 17.0 |
| Ascorbic Acid (kg) | 17.8 | 17.8 | 17.8 |
| Nucleotide Choline Premix | 13.3 | 13.3 | 13.3 |
| (kg) | | | |
| Oil Soluble Vitamin Premix | 8.26 | 8.26 | 8.26 |
| (kg) | | | |
| Carrageenan (kg) | 7.94 | 7.94 | 7.94 |
| Water Soluble Vitamin | 6.48 | 6.48 | 6.48 |
| Premix (kg) | | | |
| Magnesium Chloride (kg) | 5.31 | 5.31 | 5.31 |
| Sodium Chloride (kg) | 3.23 | 3.23 | 3.23 |
| Ferrous Sulfate (kg) | 2.63 | 2.63 | 2.63 |
| Choline Chloride (kg) | 2.45 | 2.45 | 2.45 |
| Citric Acid (kg) | 1.35 | 1.35 | 1.35 |
| L-Carnitine (g) | 149.0 | 149.0 | 149.0 |
| Riboflavin (g) | 68.0 | 68.0 | 68.0 |
| Vitamin A (g) | 35.2 | 35.2 | 35.2 |
| Beta-Carotene (g) | 16.8 | 16.8 | 16.8 |
| Potassium Iodide (g) | 2.38 | 2.38 | 2.38 |

All ingredients not designated as “organic” are non-GMO ingredients

The exemplified formula may be prepared by making at least two separate slurries that are later blended together, heat treated, standardized, diluted with an appropriate amount of water, packaged, and sterilized. Initially, a carbohydrate-mineral slurry is prepared by dissolving the selected carbohydrates (e.g., organic maltodextrin, organic corn syrup solids, organic corn syrup, organic sucrose, organic lactose) in water at 60-71° C., followed by the addition of magnesium chloride, potassium iodide, choline chloride, sodium chloride, and citric acid. The resulting slurry is held under moderate agitation at 49-60° C. until it is later blended with the other prepared slurries.

A protein-in-oil slurry is prepared by combining organic high oleic sunflower oil, organic soybean oil, and organic coconut oil at 49-60° C., followed by the addition of soy lecithin, beta-carotene, oil soluble vitamin premix, Vitamin A, carrageenan, organic non-fat dry milk and calcium carbonate. The resulting oil slurry is held under moderate agitation at 38-49° C. until it is later blended with the other prepared slurries.

A protein slurry is prepared by dissolving organic non-fat dry milk in water at approximately 49-60° C. The resulting protein slurry is held under low agitation at 49-60° C. until it is later blended with the other prepared slurries.

Water, the carbohydrate-mineral slurry, the protein-in-oil slurry, and the protein slurry are combined under adequate agitation. The pH of the resulting blend is adjusted with potassium hydroxide. This blend is held under moderate agitation at 49-60° C.

The resulting blend is heated to 71-77° C., emulsified to a maximum of 1100 psig, and then heated to 144-147° C., for about 5 seconds. The heated blend is passed through a flash cooler to reduce the temperature and then through a plate cooler to further reduce the temperature to 71-77° C. The cooled blend is then homogenized at 3900-4100/400-600 psig, and then cooled to 2-7° C. Samples are taken for microbiological and analytical testing. The mixture is held under agitation.

A water-soluble vitamin (WSV) solution and an ascorbic acid solution are prepared separately and added to the processed blended slurry. The vitamin solution is prepared by adding the following ingredients to water with agitation: potassium citrate, ferrous sulfate, WSV premix, L-carnitine, riboflavin, and the nucleotide-choline premix. The ascorbic acid solution is prepared by adding potassium hydroxide and ascorbic acid to a sufficient amount of water to dissolve the ingredients. The ascorbic acid solution pH is then adjusted to 5-9 with potassium hydroxide.

Based on the analytical results of the quality control tests, an appropriate amount of water is added to the batch with agitation to achieve the desired total solids. The product pH may be adjusted to achieve optimal product stability. The completed product is then placed in suitable containers and subjected to terminal sterilization.

At least 95% of the formula ingredient (by weight, excluding water) are organic. This particular formula may be stored, after opening, for up to about 48 hours.

### Study 1

A study is conducted to evaluate and compare the color of organic ready-to-feed infant formulas and non-organic ready-to-feed infant formulas using an Agtron 45 Colorimeter.

The formulas in the study include the organic ready-to-feed infant formula of Example 1 (Formula A), Similac® Advance® ready-to-feed infant formula (Formula B), and Isomil® Advance® ready-to-feed infant formula (Formula C). Similac® Advance® is a milk-based infant formula and Isomil® Advance® is a soy-based infant formula, both of which are non-organic, commercially available, formulas manufactured by Ross Products Division of Abbott Laboratories, Columbus, Ohio, U.S.A. All study formulas are packaged in 2 ounce plastic containers and terminally retort sterilized prior to evaluation in the study.

The formulas are evaluated by first shaking each packaged formula to achieve a homogeneous ingredient distribution, and then immediately pouring each formula into an Agtron unit sample cup (half full). The Agtron-45 colorimeter is then used to measure the spectral distribution of light to determine the monochromatic reflectance of the product sample. Scores from 0-90 are assigned (black=0 and white=90). Higher Agtron scores indicate a whiter or lighter colored product, and lower Agtron scores indicate a darker colored product.

Formulas A, B and C are evaluated for color during the course of two separate studies (Studies 1A and 1β). Samples of finished product are periodically taken throughout each batch and tested, the results of which are summarized in the following table.

| | Study #1A | | | Study #1B | | |
|---|---|---|---|---|---|---|
| | Formula A | Formula B | Formula C | Formula A | Formula B | Formula C |
| Formulation | Organic | Non- | Non- | Organic | Non- | Non- |
| | | Organic | Organic | | Organic | Organic |
| Product Type | RTF infant | Similac ® | Isomil ® | RTF infant | Similac ® | Isomil ® |
| | formula | Advance ® | Advance ® | formula | Advance ® | Advance ® |
| | | RTF | RTF | | RTF | RTF |
| Carbohydrate | 63.2% | 100% | 20% | 63.2% | 100% | 20% |
| % by weight | organic | lactose | sucrose, | organic | lactose | sucrose, |
| | sucrose, | | 80% corn | sucrose, | | 80% corn |
| | 36.8% | | syrup | 36.8% | | syrup |
| | organic | | | organic | | |
| | maltodextrin | | | maltodextrin | | |
| Agtron Score | | | | | | |
| Test 1 | 67 | 55 | 57 | 62 | 54 | 57 |
| Test 2 | 67 | 55 | 58 | 63 | 54 | 57 |
| Test 3 | 67 | 55 | 59 | 62 | 55 | 56 |
| Test 4 | 66 | 58 | 58 | 61 | 52 | 57 |
| Test 5 | 66 | 56 | 59 | 62 | 52 | 58 |
| Test 6 | 66 | 58 | 57 | 62 | 56 | 56 |
| Test 7 | 66 | 55 | 57 | 63 | 55 | 57 |
| Test 8 | 67 | 56 | 58 | 62 | 54 | 56 |
| Average | 66.5 | 56 | 57.9 | 62.1 | 54 | 56.8 |

As shown in the above data table, the organic ready-to-feed formula (Formula A) has a significantly higher Agtron color score (p=0.0191) than either of the non-organic formulas (Formulas B and C), and therefore the organic ready-to-feed formula has a significantly whiter appearance than either of the non-organic formulas.

### Study 2

A study is also conducted to evaluate and compare the color of reconstituted organic infant powder and reconstituted non-organic infant powder using an Agtron 45 Colorimeter as described in Study 1.

The formulas in the study include Similac® Organic powder infant formula (Formula C) and Similac® Advance® powder infant formula (Formula D). Similac® Advance® and Similac® Organic are milk-based infant formulas commercially available from Ross Products Division of Abbott Laboratories, Columbus, Ohio, U.S.A. Both are spray dried and packaged into composite cans prior to evaluation in the study. Seven batches of each study formula are manufactured and tested, the results of which are summarized in the following table.

| | Similac ® Organic Infant | Non-organic Similac ® |
|---|---|---|
| | Powder | Advance ® Infant Powder |
| | Formula C | Formula D |
| Wt. % of total | 63.2% organic sucrose, | 100% lactose |
| carbohydrate | 36.8% organic maltodextrin | |
| Agtron Scores | | |
| Batch 1 | 66 | 72 |
| Batch 2 | 72 | 73 |
| Batch 3 | 66 | 75 |
| Batch 4 | 72 | 74 |
| Batch 5 | 64 | 73 |
| Batch 6 | 63 | 72 |
| Batch 7 | 66 | 71 |
| Average | 67 | 72.9 |

As shown in the above table, the reconstituted organic powder (Formula C) has a lower average Agtron color score than the reconstituted non-organic formulas (Formulas D), and therefore the reconstituted organic powder has a darker appearance than the reconstituted non-organic formula.

### Conclusions

The above studies show that the organic ready-to-feed infant formulas have significantly higher Agtron color scores (p=0.0191), and are therefore whiter in appearance, than the non-organic ready-to-feed formulas in the study. This result is unexpected since it is generally known that many organic products have a darker or less pure appearance than their non-organic counterparts. The organic infant powder, for example, has a darker appearance than its non-organic counter part (see above Study 2).

The data from the studies therefore shows that the improved whiter product color is uniquely associated with the organic ready-to-feed formulas, not the organic powder formulas.

What is claimed is:

1. A composition comprising
(a) organic lipid;
(b) organic protein; and
(c) organic carbohydrate, wherein the organic carbohydrate is a blend containing
(i) a first carbohydrate selected from the group consisting of organic maltodextrin, organic corn syrup solids, and organic corn syrup, and
(ii) a second carbohydrate selected from the group consisting of organic sucrose and organic lactose,
wherein the composition is an organic nutritional formula in ready-to-feed liquid form.

2. The composition of claim 1 wherein the composition has a weight ratio of the first carbohydrate to the second carbohydrate from about 1:10 to about 10:1.

3. The composition of claim 2 wherein the weight ratio of the first carbohydrate to the second carbohydrate is from about 3:1 to about 1:1.

4. The composition of claim 1 wherein the first carbohydrate comprises organic maltodextrin and the second carbohydrate comprises organic sucrose.

5. The composition of claim 1 wherein the composition is substantially free of added organic lactose.

6. The composition of claim 4 wherein the weight ratio of the organic maltodextrin to the organic sucrose is from about 1:10 to about 10:1.

7. The composition of claim 4 wherein the weight ratio of the organic maltodextrin to the organic sucrose is from about 3:1 to about 1:1.

8. The composition of claim 6 wherein the organic maltodextrin is organic corn maltodextrin.

9. The composition of claim 1 wherein the composition comprises, as a percentage of total calories, from about 30% to about 60% carbohydrate, from about 20% to about 60% lipid, and from about 5% to about 50% protein.

10. The composition of claim 1 wherein the composition comprises, as a percentage by weight of total fat in the composition, from about 1.8% to about 3.0% lecithin.

11. The composition of claim 1 wherein the composition is substantially free of added organic whey protein.

12. The composition of claim 1 wherein the organic protein is organic non-fat dry milk.

13. The composition of claim 1 wherein the composition is retort sterilized.

14. A composition comprising
(a) organic lipid;
(b) organic protein; and
(c) organic carbohydrate, wherein the organic carbohydrate is a blend containing
(i) a first carbohydrate selected from the group consisting of organic maltodextrin, organic corn syrup solids, and organic corn syrup, and
(ii) a second carbohydrate selected from the group consisting of organic sucrose and organic lactose,
wherein the composition is an organic infant formula in ready-to-feed liquid form.

15. The composition of claim 14 wherein the composition has a weight ratio of the first carbohydrate to the second carbohydrate from about 1:10 to about 10:1.

16. The composition of claim 15 wherein the weight ratio of the first carbohydrate to the second carbohydrate is from about 3:1 to about 1:1.

17. The composition of claim 14 wherein the first carbohydrate comprises organic maltodextrin and the second carbohydrate comprises organic sucrose.

18. The composition of claim 14 wherein the composition is substantially free of added organic lactose.

19. The composition of claim 17 wherein the weight ratio of organic maltodextrin to organic sucrose is from about 1:10 to about 10:1.

20. The composition of claim 17 wherein the weight ratio of organic maltodextrin to organic sucrose is from about 3:1 to about 1:1.

21. The composition of claim 14 wherein the composition has a caloric density of from about 642 to about 1014 kcal/liter, on a ready-to-feed basis.

22. The composition of claim 17 wherein the organic maltodextrin is organic corn maltodextrin.

23. The composition of claim 14 wherein the composition comprises, as a percentage of total calories, from about 30% to about 60% carbohydrate, from about 20% to about 60% lipid, and from about 5% to about 50% protein.

24. The composition of claim 14 wherein the composition comprises, as a percentage by weight of total fat in the composition, from about 1.8% to about 3.0% lecithin.

25. The composition of claim 14 wherein the composition is substantially free of added organic whey protein.

26. The composition of claim 14 wherein the organic protein is organic non-fat dry milk.

27. The composition of claim 14 wherein the composition is retort sterilized.
